(19) United States
(12) Patent Application Publication
(10) Pub. No.: US 2016/0116112 A1
(43) Pub. Date: Apr. 28, 2016

(54) Modular Assembly For Fabricating A Hollow Structure

(71) Applicant: Anchor Concrete Products Ltd., Kingston (CA)

(72) Inventors: Jeff Bradfield, Kingston (CA); David Dines, Kingston (CA); Tony De La Concha, Kingston (CA); Ibrahim Nour Eldin, Kingston (CA); Matthew Morton, Kingston (CA); John Tait, Kingston (CA); Gerard McKenna, Kingston (CA)

(21) Appl. No.: 14/918,669

(22) Filed: Oct. 21, 2015

Related U.S. Application Data
(60) Provisional application No. 62/067,785, filed on Oct. 23, 2014.

(51) Int. Cl. F16S 5/00; E02B 11/00; E01F 5/00; E02D 29/00

(52) U.S. Cl. CPC F16S 5/00; E02D 29/10; E02B 11/005; E01F 5/005

(57) ABSTRACT

The invention relates to a modular system for assembling a hollow structure. The system comprises segments for assembly into modules to assemble hollow structures such as culverts and water-retention systems. The segments comprise opposing sidewalls and a deck spanning said sidewalls having opposing sides and opposing ends which are assembled in inverted, vertically aligned relation to each other to form a hollow module. The segments engage each other with mutually engaging three dimensional structures that prevent lateral and vertical slippage between the segments. The segments may include half-columns that meet along the plane of engagement to form full-height load bearing columns in the assembled structure.

### CROSS-REFERENCE TO RELATED APPLICATIONS

This application claims the benefit of U.S. Provisional Application No. 62/067,785, filed Oct. 23, 2014, the entire disclosure of which is hereby incorporated herein by reference.

### FIELD OF THE INVENTION

The present invention relates to prefabricated modules for assembly into partially or fully enclosed hollow structures such as passageways, culverts or other roadway components as well as other uses such as parking garages and water holding tanks. More particularly, the invention relates to prefabricated modules which are assembled from separate segments.

### BACKGROUND

Prefabricated structural modules, which may be fabricated from concrete or other moldable material, can be configured to provide a wide variety of assembled structures. For example, prefabricated modules can be assembled into culverts, pipes or passageways for diverting water or other applications, as well as water retention systems for homes, businesses communities and other applications. As well, prefabricated modules can be used to assemble structures that serve other functions, such as storage or other utility structures, parking facilities, bridges or over/underpasses and a wide variety of other uses. Structural modules or components thereof may be prefabricated from concrete and transported to a remote location for assembly. Modules or their components should be of a size and weight that permits them to be transported and assembled using generally conventional equipment and facilities. Modules should be capable of being assembled into a wide variety of modules and structures that preferably have a high degree of durability and strength, ease of installation and if required, water tightness.

Conventional modules and modular systems typically are designed for specific end uses, such as storm water retention, subsurface culverts and the like. However, it can be desirable to provide structural modules that may be assembled into a relatively wide variety of structures with little or no modification to the basic module design. Furthermore, it is desirable to provide modules that are relatively compact and lightweight that can be easily transported and assembled using conventional equipment, while still being capable of assembly into relatively large structures that have a relatively high weight-bearing capacity. Furthermore, it is desirable to provide modules that when assembled can be sealed against water leakage, in particular at the joints between modules. This is particularly desirable for modules used for water retention or derivation, such as water retention tanks, culverts and the like.

Modular assemblies must often be capable of a high degree of load bearing, for example when used as underpasses, bridges or culverts for roadways or other applications in which significant weight-bearing is required.

A modular assembly is disclosed, for example, in U.S. Pat. No. 8,770,890 to May et al.

### SUMMARY

The present invention relates to improved segments, modules and modular assemblies that may be fabricated from precast concrete, which have at least the potential to address the requirements and needs discussed herein.

According to one broad aspect, the invention relates to a modular system for assembling a hollow structure. Modules are assembled from first and second segments each being defined by opposing ends with an elongate axis between said ends. The assembled module has opposing upper and lower decks, each of which has opposing sides and opposing ends. The respective surfaces of deck consist of opposing upper and lower surfaces, opposing side edges and opposing end edges. The first and second segments are configured for assembly in inverted, vertically aligned relation to each other to form a hollow module comprising the opposed upper and lower decks. The first and second segments are configured to engage each other when assembled in vertically and/or axially aligned relationship with mutually engaging three-dimensional structures that restrict lateral and/or vertical slippage between the segments.

According to a further general aspect, the system comprises multiple segments that may be assembled into vertical aligned modules, which in turn can be axially aligned with similar modules to form elongate structures such as culverts and water-retention systems.

The segments may, in one aspect, each comprise opposing sidewalls at their sides with the deck spanning the sidewalls. The first and second segments are configured for assembly in axially and vertically aligned relation to each other to form a hollow module wherein the respective sidewalls when assembled form essentially continuous outer walls of said structure and the respective decks oppose each other. The first and second segments are configured to engage each other when assembled in vertically aligned and/or end to end relationship with mutually engaging structures. The mutual engagement is provided by interlocking or mutually engaging three dimensional structural elements that restrict lateral slippage between segments and/or lateral/vertical slippage between adjacent modules. The vertical alignment between the segments comprises vertical alignment of the sidewalls. The ends of the respective segments may also be vertically aligned or may be out of alignment to form a staggered vertical joint structure.

In one aspect, the deck may have a cantilever member protruding from a lateral edge of a deck for interlocking with a corresponding cantilever member in an abutting, axially aligned deck of a second segment. The cantilever joint member comprises a shelf protruding from an edge surface of the deck which is configured to bear upon or be borne upon a similar shelf protruding from a corresponding edge of the deck of a corresponding one of the segments when assembled in axial alignment. The deck may comprise opposing end edge surfaces and respective ones of the shelves of said deck are configured to engage and bear upon or be borne upon shelves of corresponding ones of said segments when assembled in axial alignment. A deck may have two exposed end edge surfaces, one exposed end edge surface or no exposed end edge surface depending on whether the segment includes no end walls, one end wall or two opposing end walls; it will be seen that the number of walls in the module relates to the number of exposed edge surfaces that are present at the wall-free edges of the decks.

In one aspect, the cantilever joint members consist of four different cross sectional profiles that may be repeated in a multi-module structure. The four profiles consist of a first configuration for a first end surface of an upper deck, a second configuration for an opposed second surface of a second upper deck, a third configuration for a third end surface of a lower deck and a fourth configuration of an opposed lower deck. The opposing decks interlock in a load-bearing cantilever joint configuration when brought into end to and abutting relationship.

In another aspect, vertical edge surfaces of the respective sidewalls may comprise vertically oriented protrusions which are continuous with the shelf structures of the decks. The protrusion interlocks with a similar protrusion in an adjacent segment when the respective modules are assembled in end-to-end axially aligned relationship.

The segments and modules may be open at both ends for assembly into an open-ended four-sided hollow structure. Others of the segments may have a single end wall for assembly into a five-sided hollow structure having one closed end or two end walls at opposing ends for assembly into a fully enclosed, six-sided structure.

According to another aspect, the segments may, (depending on span and loading) further comprise at least one half-column protruding from a surface of said deck towards an opposing one of said segments whereby when said first and second segments are assembled in vertically aligned relationship, the half-columns abut each other to form load-bearing continuous columns extending between opposing ones of said decks. A “half-column” is a vertically-oriented member having a length which is half the length of a full-height column, and which is configured to be vertically aligned with and abut a similar half column to form a full-height column that for structural purposes is equivalent to a monolithic weight-bearing column. The exposed ends of the half-columns may comprise interlocking projections and recesses, such as a mortice and tenon configuration. The columns may be configured such that a pair of the half columns is aligned along an axis transverse to the elongate axis of each module.

According to another aspect, the sidewalls of the first segment may have axially-aligned lower edges comprising a tongue and groove structure configured to interlock with similar structures in the upper edges of sidewalls of the second segment when assembled in vertical alignment.

### Definitions

In this patent specification, the terms defined below shall have the meanings set forth herein, unless otherwise stated or the context clearly requires otherwise.

“Module” refers to a structural member that can be assembled with other like modules in an interchangeable fashion into a structure. A given assembled structure may be composed of multiple identical modules or a plurality of module types. A module may be composed of multiple segments, or it may be a monolithic member.

“Segment” refers to a structural member that forms part of a module. Multiple segments having the same or different configurations may be assembled into a module.

The terms “slab” and “deck” are generally used interchangeably and refer to an essentially continuous plate-like member.

“Cantilever” refers to a structure having a member projecting horizontally outwardly from a surface, supported only at one end of the member other than when bearing on another member. A cantilever member is normally capable of load bearing in either of a downwards or upwards direction when opposing ones of the cantilever members engage each other.

“Column” is a vertically-oriented structure that is normally load-bearing when located in an assembled structure. A column may have any suitable cross-sectional configuration. A “half column” is an upper or lower half of a column that may be mated with a similar opposing half column to form a column.

Directional references herein are used purely for convenience and are not intended to limit the scope of the invention in any respect. For example, directional references such as vertical, upwardly, horizontal and like, are intended purely for ease of description. Furthermore, it will be understood that embodiments of the invention may be produced on essentially any scale. Accordingly, references to specific dimensions are, unless otherwise expressly stated, not intended to limit the scope of the invention in any respect. The embodiments described herein are intended purely for illustration purposes, to provide teachings that describe certain aspects of the invention. The specific embodiments described herein are purely by way of example and illustration and are not intended to limit the scope of the invention in any respect.

### BRIEF DESCRIPTION OF THE DRAWINGS

FIG. 1 is an isometric view of an assembly according to an embodiment of the invention, shown with the segments and modules separated from each other for illustration.

FIG. 2 is an isometric view of the encircled portion of FIG. 1.

FIGS. 3A and 3B are sectional views of portions of the assembly, showing the overlapping portions of the respective horizontal slabs thereof.

FIG. 4 is a side view of an embodiment of an assembled structure wherein the segments are assembled in an overlapping, staged configuration.

FIG. 5 is a side view of the encircled portion of FIG. 4.

FIG. 6 is a further side view of the embodiment of FIGS. 4 and 5.

FIG. 7 is a front elevational view of a module having an end wall which may form a closed end of an assembled structure.

FIG. 8 is a cross-sectional view along line 8-8 of FIG. 7.

FIG. 9 is a cross-sectional view of a module having a configuration which is a mirror image of the module shown in FIGS. 7 and 8, which may form a closed end of an assembled structure, opposed to the closed end of FIGS. 7 and 8.

FIG. 10 is a cross-sectional view of a module having open opposing ends.

FIG. 11 is an isometric view of an assembly showing opposing end segments having closed ends and an open-ended segment sandwiched between the end segments to form an enclosed six-sided structure.

FIG. 12 is an isometric view showing of a four-sided structure composed of multiple open-ended segments positioned in end-to-end abutting relationship, in exploded view.

FIG. 13 is a further isometric view of the structure of FIG. 12, assembled together.

FIG. 14 is an isometric view of a further embodiment of the invention, partially exploded.

FIG. 15 is an isometric view of an alternative structure according to the invention.

FIG. 16 is a further isometric view of the structure of FIG. 15.

FIG. 17 is an isometric view of an alternative structure according to the invention.

FIG. 18 is a further isometric view of the structure of FIG. 17.

FIG. 19 is an isometric view of a further embodiment of the invention, showing a structure free of end and side walls.

FIG. 20 is a further isometric view of the embodiment of FIG. 19.

FIG. 21 is an isometric view of a module similar to the embodiment of FIG. 19, wherein overlapping cantilever members project from side edge surfaces of upper and lower decks of the module.

FIG. 22 is a further isometric view of a partially assembled structure according to the embodiment of FIG. 21.

FIG. 23 is an isometric view of a module wherein cantilever members project from each of the side and end edge surfaces of the upper and lower decks.

FIG. 24 is a further isometric view of a partially assembled structure according to the embodiment of FIG. 23.

FIG. 25 is an isometric view of an assembled structure according to a further embodiment of the invention.

FIG. 26 is an isometric view of an assembled structure according to a further embodiment of the invention.

### DETAILED DESCRIPTION

### Segments and Modules

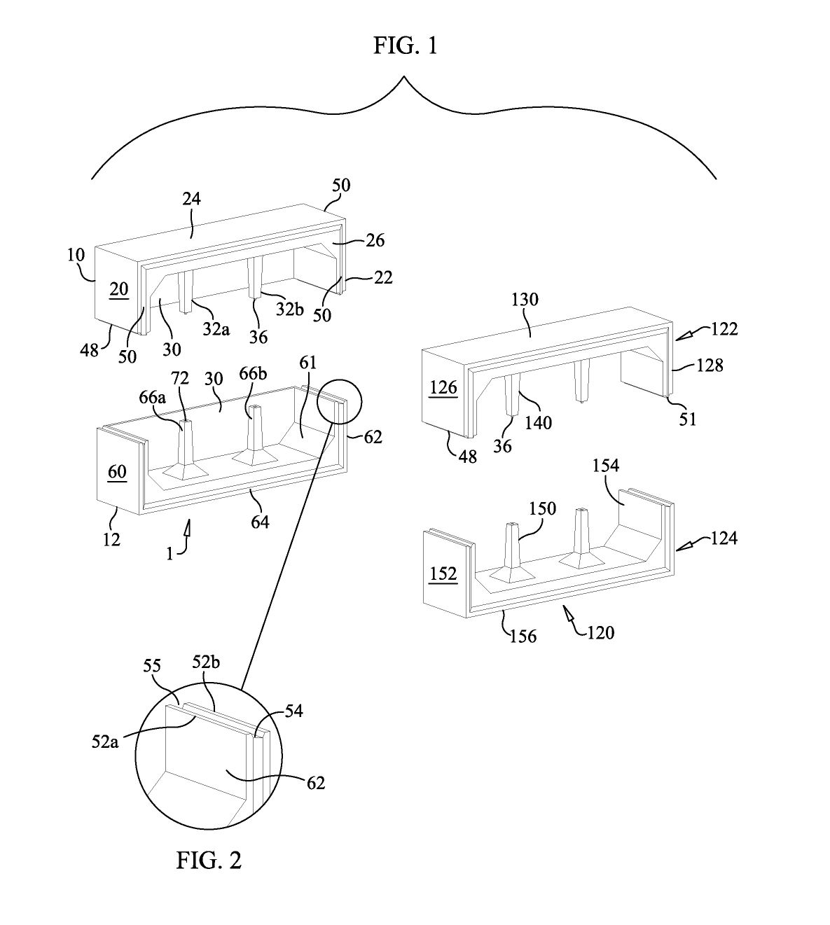

FIGS. 1-8 depict upper and lower segments 10 and 12 respectively, which are configured for assembly into a partially enclosed, hollow module 1 having an open first end and an opposed second end which is closed. Module 1 may comprise a modular component of a larger structure or it may instead form the entire finished structure. Segments 10 and 12 have opposed ends with an elongate axis “A” between the respective ends. A first end 28 (see FIG. 8) is open and the opposed second end is closed with end wall 30.

Upper and lower segments 10 and 12 are similar (but not identical nor mirror image) in configuration to each other and are configured to be assembled in vertical alignment with each other to form module 1.

Segments 10 and 12 (and the similar segments described herein) are fabricated from a moldable material such as concrete and are typically pre-cast at a concrete plant and transported to a remote assembly. Preferably, the concrete is reinforced and may be pre-stressed. The materials used for reinforcing and pre-stressing comprise any suitable reinforcing materials known to art and may be ferrous and/or non ferrous.

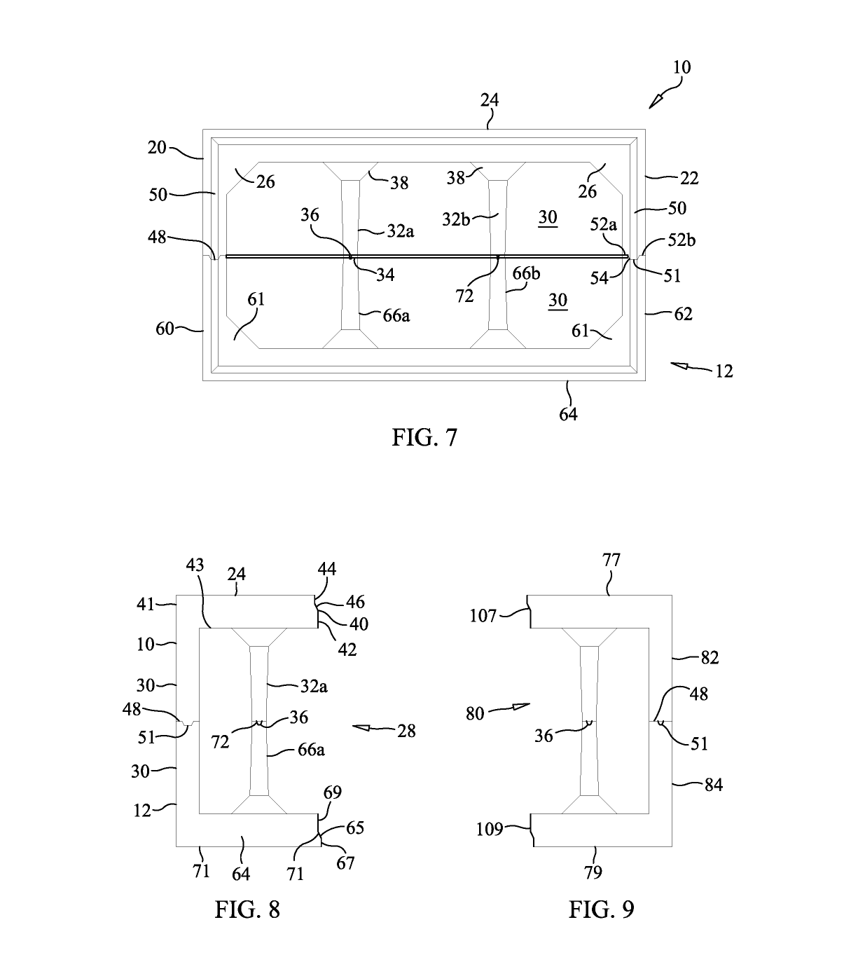

As seen in more detail in FIGS. 7 and 8, upper segment 10 comprises opposing side walls 20 and 22 and an upper slab 24 which spans side walls 20 and 22 and is supported thereon. Slab 24 has opposing ends which correspond with the ends of segment 10 and opposing lateral sides, with a longitudinal axis extending between the ends, which is parallel or coaxial with axis A. Slab 24 forms a load-bearing upper deck which comprises an uppermost surface of upper segment 10. A similar slab 64 forms a lowermost surface of lower segment 12 and forms a lower deck of the assembled module 1. Upper and lower decks 24 and 64 oppose each other and are normally vertically aligned in the assembled module 1. Decks 24 and 64 comprise continuous upper and lower surfaces of module 1. Each of side walls 20 and 22 meet slab 24 at a corner gusset 26 extending parallel to the longitudinal axis of the entire assembly between ends 28 and 30. Gusset 26 has a triangular cross section, which provides additional structural support for slab 24 to transmit the weight of slab 24 to side walls 20 and 22. Walls 20 and 22 and slab 24 form an inverted U-shaped structure or segment, which defines an interior space.

Upper segment 10 further comprises half-columns 32a and 32b which extend downwardly from the underside of slab 24 towards the interior space of segment 10. Lower segment 12 has similar half-columns 66a and b, described below, that extend upwardly to join with half-columns 32 to form structurally continuous weight-bearing columns extending between slabs 24 and 64. The number and dimensions of half columns 32 may vary depending on the structural requirements of the assembled structure. Furthermore, in some cases interior columns 32 and 66 may not be required in the structure, for example if the structure is expected to experience reduced load-bearing requirements and/or reduced unsupported span distances relative to structures that normally require interior columns. Half-columns 32 may have a square or rectangular cross-sectional configuration, as illustrated, or any other suitable cross-sectional configuration. In the present example, two half-columns 32 are provided in side by side relation along an axis which is transverse to the longitudinal axis A. Half-columns 32 may taper inwardly from slab 24 to their exposed end surfaces 34 (see FIG. 7). In other embodiments, half-columns 32 may be non-tapering (not shown). A tenon 36 projects downwardly from each end of surface 34 of half columns 32a and b. Half-column 32 joins slab 24 at a neck 38, which flares outwardly from half-column 32 to slab 24 to effectively transmit load to the shaft of half-column 32. Optionally, the columns described herein may intersect with the slab without the neck, for example to conserve floor or ceiling space.

Sidewalls and end walls 20, 22 and 30, as well as half columns 32, all extend downwardly to the same extent wherein the lower surfaces thereof are co-planar and comprise a plane of engagement with the corresponding upper surfaces of lower segment 12.

In one embodiment, half-columns 32 may range from 0.5 m to 2.0 m in height. Their width can range from 0.15 m to 0.5 m at the lower surface at the plane of engagement and from 0.15 to 0.6 m where column 32 meets neck 38. Tenon 36 has an overall height of between 25 mm to 75 mm.

Slab 24 comprises opposing end surfaces 40 and 41 at the respective ends thereof. A first end surface 40 is adjacent to open end 28 of segment 10 and normally faces an adjacent modular segment when module 1 is assembled end to end with similar modules to form an elongate segmented structure with a hollow interior. An opposing end 41 of slab 24 meets end wall 30. End surface 40 has a stepped configuration which will be described in more detail below, which cooperates with a similar structure an adjoining segment to interlock in a cantilever-type joint.

Side walls 20 and 22 have horizontally-disposed lower edges 48 that are aligned with axis A and vertically disposed end edges 50. End edges 50 are exposed at the open end 28 of segment 10 (see FIG. 1) and define the open end of segment 10. The stepped configuration of end 40 of slab 24 is continuous with the end edges 50 of side walls 20 and 22, which likewise comprise outwardly projecting projections 42, inwardly stepped recesses 44 and intermediate slopping shoulders 46.

The lower edges 48 of sidewalls 20 and 22 are configured to rest upon and engage corresponding upper edges of lower segment 12 with an interlocking engagement, such that the respective sidewalls are vertically aligned to form an essentially continuous wall of the assembled structure. The exposed lower edges of walls 20 and 22 each comprise a central downwardly projecting tongue 51 flanked by recessed portions 52a and 52b (see FIG. 2), which fits in a corresponding groove 54 recessed into the upper surface of the side walls of the lower segment 12, as described below. Grout or other adhesive/filler 55 may be applied between the respective contacting surfaces of the segments to seal the joints between segments and improve structural rigidity.

Turning now to the opposed lower segment 12, as seen in FIGS. 7 and 8, this has a similar configuration to upper segment 10. Segment 12 comprises side walls 60 and 62, a floor slab 64 that spans side walls 60 and 62 and upwardly-projecting half columns 66a and 66b. Lower gussets 61 buttress walls 60 and 62 to slab 64. The vertical end surfaces of walls 60 and 62 and slab 64 have a stepped configuration matching that of upper segment 10. Slab 64 has an end surface 65 which will be described below for interlocking with end surface 109 of segment 84 or end surface 86 of segment 156.

Half-columns 66a and b each have a flat upper surface 70, having a mortice 72 recessed therein. Mortice 72 is configured to snuggly receive tenon 36 therein to interlock the respective exposed end surfaces of half-columns 32 and 66 when assembled. An adhesive such as grout may be applied between the contacting mortice and tenon members. After the grout or other adhesive hardens, the respective half-columns effectively form a continuous, monolithic structural member. Half-columns 32 and 66 are configured and located within segments 10 and 12 such that when assembled in vertical alignment, the respective half-columns are vertically aligned and their exposed surfaces meet whereby tenon 36 fits within mortice 72 and columns 32 and 66 form an essentially continuous load-bearing column spanning the full height of the assembled module. The dimensions of half-columns 66 match those of half-columns 32 whereby when module 1 is assembled and columns 32 and 66 meet at their plane of engagement, the respective half-columns define mirror images with the respective mortice and tenons thereof interlocking.

The respective half-columns 32 and 66 thus transfer load from upper slab 24 to lower slab 64 when the respective segments 10 and 12 are assembled. In a similar fashion, side walls 20 and 22 of upper segment 10 bear upon the sidewalls 60 and 62 of lower segment 12 using grout if necessary to form essentially continuous, load-bearing sidewalls of the assembled module 1. Side walls 60 and 62 have recessed grooves 54 within their upper surfaces extending lengthwise the full length of the respective walls, configured to snuggly receive projecting tongues 51 from the sidewalls 20 and 22 of corresponding upper segment 10. In this fashion, a tongue and groove (or other suitable structural connection) interlocking structure is provided between respective side walls and a mortice and tenon (or other suitable structural connection) interlocking structure is provided between upper and lower columns so as to rigidly interlock upper and lower segments 10 and 12.

The vertical walls of the modules (e.g. sidewalls 20, 22, 60 and 62; end walls 30, and similar walls described herein) may be in the range of 100 mm to 800 mm thick, but commonly between 200 mm to 300 mm in thickness. These walls range in both width and height from 500 mm to 4 m. Slabs 24 and 64 may range in thickness between 150 mm and 600 mm thick, but commonly 200 mm to 400 mm in thickness. Slabs 24 and 64 may range in length along axis A from 500 mm to 4 m, and in width between the sidewalls from 4 m to 15 m or more.

FIG. 9 depicts an opposing end module 80, comprising upper and lower second end segments 82 and 84 having upper and lower slabs 77 and 79 respectively. Upper slab 77 has an exposed end surface 107 and lower slab 79 has an exposed end surface 109. Segments 82 and 84 have configurations substantially identical to first end segments 10 and 12, being substantially mirror images thereof. However, module 80 differs from being a precise mirror image of module 1 in that it is configured to interlock therewith if brought into end to end abutting relation. As a result, if first and second opposing modules 1 and 80 are brought into end-to-end contact with each other, the respective exposed end surfaces 40 and 107 on the one hand and 71 and 109 on the other hand interlock, as described below.

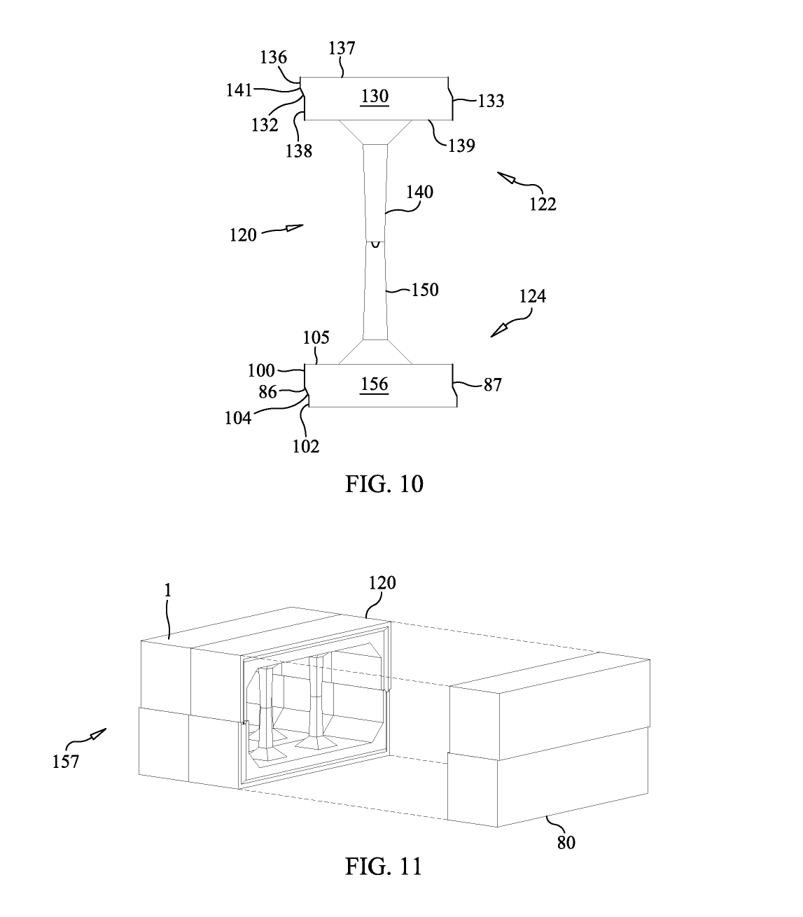

FIGS. 1 and 10 depict open-ended (middle) modules 120, having both opposing ends open. Module 120 thus comprises in essentially tubular structure having opposed open ends to form a four-sided structure comprised of upper and lower segments 122 and 124. Upper segment 122 comprises opposing side walls 126 and 128, spanned by an upper slab 130. Half columns 140 decend downwardly from the lower (interior) surface of slab 130. As seen in FIG. 10, slab 130 comprises exposed opposed end surfaces 132 and 133, which partially define the open ends of segment 120. Surfaces 132 and 133 are configured to provide a cantilevered joint similar in configuration to edge surfaces 40 and 86 of the respective end segments.

Turning to the opposing lower segment 124, this has a complimentary structure to upper segment 122, including upwardly-projecting columns 150 and opposing side walls 152 and 154 (seen in FIG. 1), and a lower slab 156. The exposed opposing end surfaces 86 and 87 of lower segment 124 have a configuration continuous with and identical to the end edge surfaces of upper segment 122. Furthermore, as with end segments 10 and 12, horizontal surfaces of the end walls and columns have an interlocking configuration.

The upper and lower segments described herein may have equal top to bottom heights, or unequal heights.

### Cantilever Joint Configuration

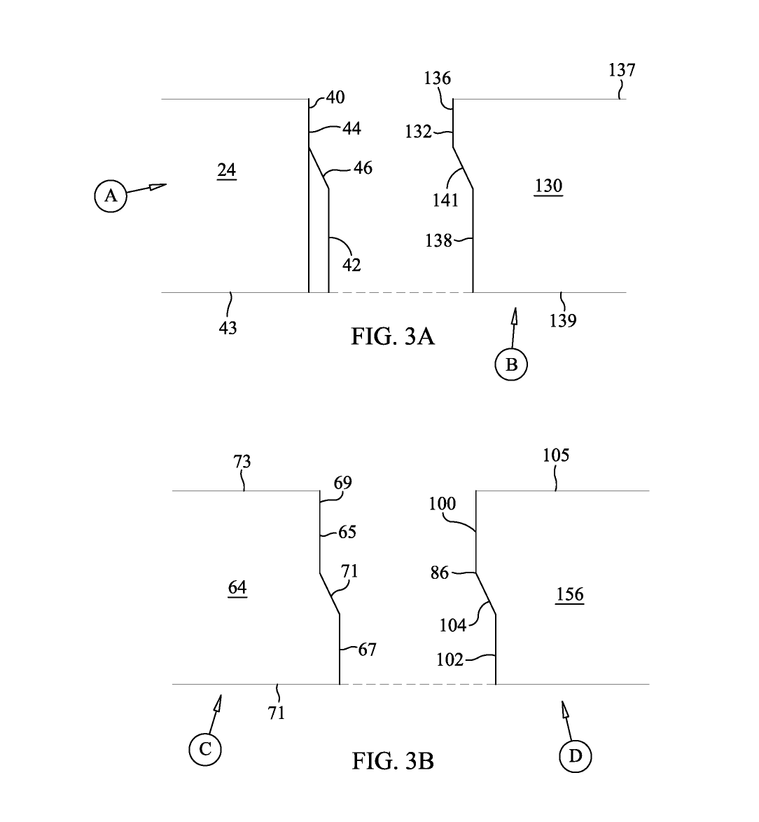

The segments described herein have four different configurations or profiles, identified as A-D, of their respective end surfaces of the horizontal slabs which interlock to form cantilever joints when assembled in end to end axially aligned relationships. Repeating patterns of configures A-D may be provided. The term “cantilever joint” as used herein refers to an overlapping configuration wherein a cantilever member projecting from a first module rests upon and transfers load to a similar cantilever member projecting from an abutting second module. The respective cantilever members are thus configured to rest one upon the other when the respective modules are horizontally aligned. FIGS. 3A and 3B show the interlocking function between the four slab end surface configurations, identified as configurations A through D. The four different configurations are as follows:

A) First end surface: end surface 40 of slab 24 (segment 10) defines a first end surface configuration A. Surface 40 comprises an outwardly protruding shelf 42 adjacent the lower surface 43 of slab 24 and an inwardly stepped recess 44 adjacent to the upper surface of slab 24. A sloping shoulder 46 forms the transition between portions 42 and 44. As will be described below, the configuration of end 40 provides a cantilever joint between adjacent segments of the adjacent modular structure wherein shelf 42 and shoulder 46 support a corresponding shelf and shoulder of an adjacent segment.

B: Second end surface: end surface 132 of slab 130 of segment 122 defines a second end surface configuration B, which mates with first end surface 40. Surface 132 comprises an outwardly projecting cantilever (shelf) region 136, an inwardly stepped region 138 and a sloping transition zone 141. Shelf 136 is adjacent the upper surface 137 of slab 130, while recessed portion 138 is adjacent the lower surface 139 thereof.

C: Third end surface: end surface 65 of lower slab 64 (segment 12) defines a third end surface C. Surface 65 comprises a protruding shelf 67 continuous with the bottom surface of slab 64, a recess 69 adjacent to the upper surface 73 of slab 64 and a sloping shoulder 71 which forms a transition zone between shelf 67 and recess 69.

D: Fourth end surface: end surface 86 of lower slab 156 of segment 124 defines a fourth end surface D, which mates with third end surface 65. Surface 86 comprises an outwardly projecting shelf 100 which is continuous with upper surface 105 and above inwardly stepped region 102. A sloping shoulder 104 forms the transition zone between the respective regions 100 and 102.

The four configurations described above are repeated within the various segments described herein to form an interlocking structure when the segments are assembled in various configurations. Accordingly, module 120 comprises upper and lower end surfaces 133 and 87 which are opposed to end surfaces 132 and 86. These in turn are identical in configuration to the first and third end surfaces (A and C). Similarly, end module 80 comprises upper and lower end surfaces 107 and 109 which are identical in configuration to the second and fourth end surfaces (B and D). In this fashion, when assembled together, the shelves of the four end surface configurations all fit within corresponding inwardly stepped regions of abutting segments whereby the respective shelves and shoulders rest one upon other. Any number of segments and modules may be combined with these four combinations of deck end surface profiles. This interlocking structure provides a cantilever joint configuration which restricts vertical slippage between the respective segments and allows vertical forces to be transmitted from one module to another via the cantilever joint configuration. It will be seen that an end module 1 or 80 that includes an end wall, wherein the upper and lower decks comprise only a single exposed end surface, comprise two distinct end surface profiles. A middle module 120 wherein the decks have both end surfaces exposed comprises all four profiles on the respective end surfaces of the upper and lower decks. The middle modules can thus join with either one of the end modules or another middle module 120.

In one aspect, the respective shelves of upper and lower decks may differ in top to bottom depth.

### Structures

Turning to FIG. 11, a fully enclosed six-sided structure 157 may be formed by sandwiching an open-ended module 120 between opposing end modules 1 and 80. The abutting vertical surfaces of the respective segments interlock to form a unitary rigid structure having a hollow interior spanned by supporting columns. Such a structure may be used, for example, for water retention. For this purpose, it can be desirable to provide inlet and outlet openings, not shown. Furthermore, to improve the water tight seals between the respective segments, the joints may be grouted or otherwise sealed to minimize water leakage and provide full bearing transfer from upper to lower segments. Furthermore, it will be seen that multiple four-sided modules 120 may be provided to vary the overall length of the resulting enclosed structure. As well, one of end modules 1 or 80 may be dispensed with, to provide a five-sided structure which combines modules 1 and 120 having a closed first end and an open second end (see FIG. 1). Such a structure may be used, for example, as a storage structure, a vehicle parking structure, or any other use that benefits from an open end.

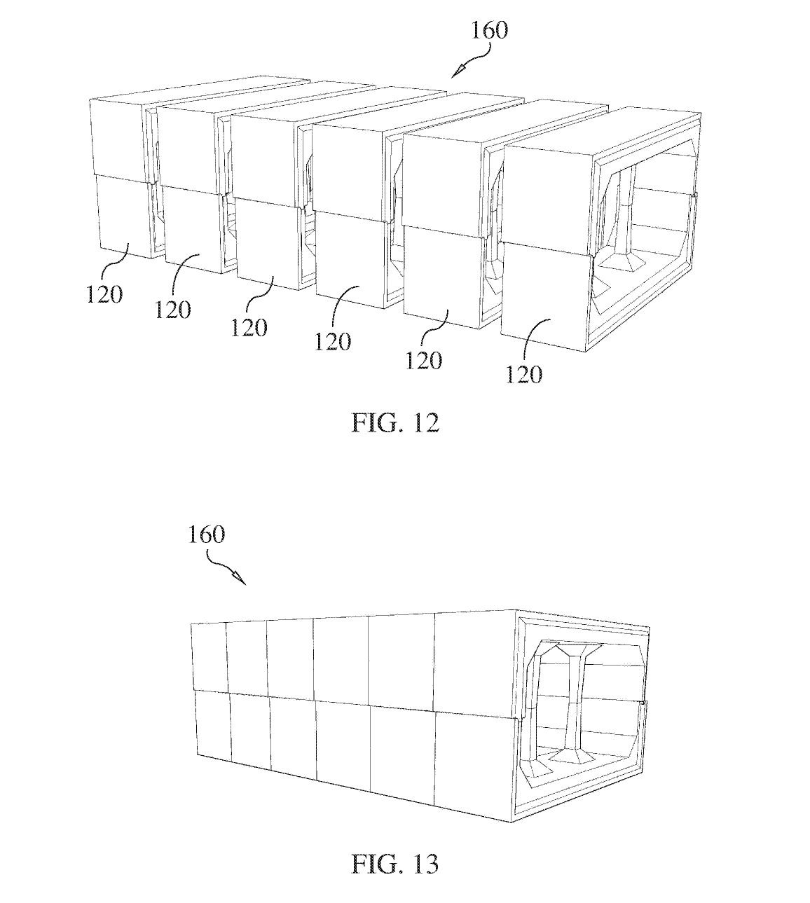

FIGS. 12-15 illustrate a structure 160, comprised of multiple open-ended modules 120, positioned in end-to-end (axially aligned) abutting relationship to form an elongated 4-sided structure 160. The opposing ends of the resulting structure are both open. As a result, the structure may be used, for example, as a culvert or as an over or underpass for a roadway, rail bed or the like.

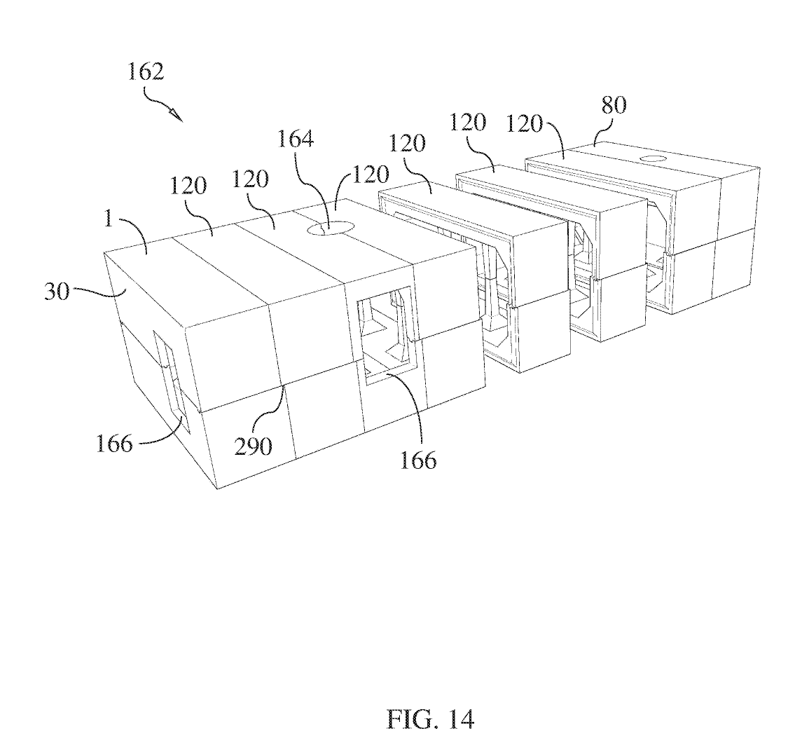

FIG. 14 shows a structure 162 having two opposed closed ends, both closed by end walls 30. Any one or more of the walls and slabs (e.g. end walls 30, side walls and/or slabs) may be provided with cutouts, which may comprise circular or oval cutouts 164 or rectangular cutouts 166, or any other suitable configuration. The cutouts can provide passageways for water, or serve other functions.

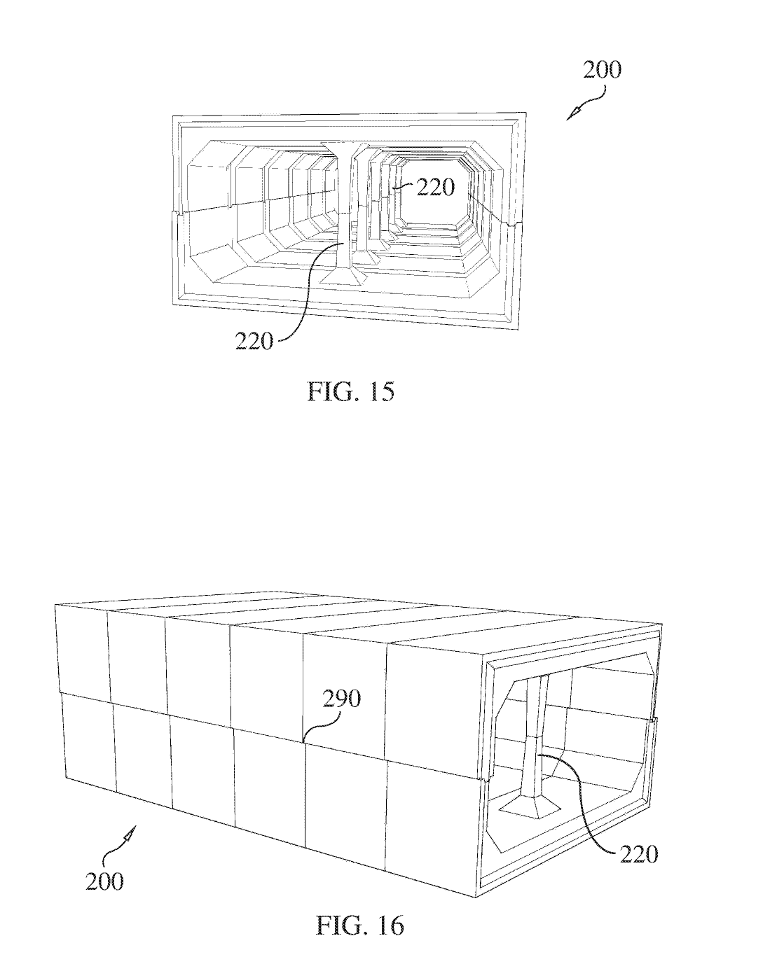

FIGS. 15 and 16 illustrate an embodiment of a structure 200 having a single, central column 220 therein. This structure may comprise one or more of a first or second end wall segment or open ended segment.

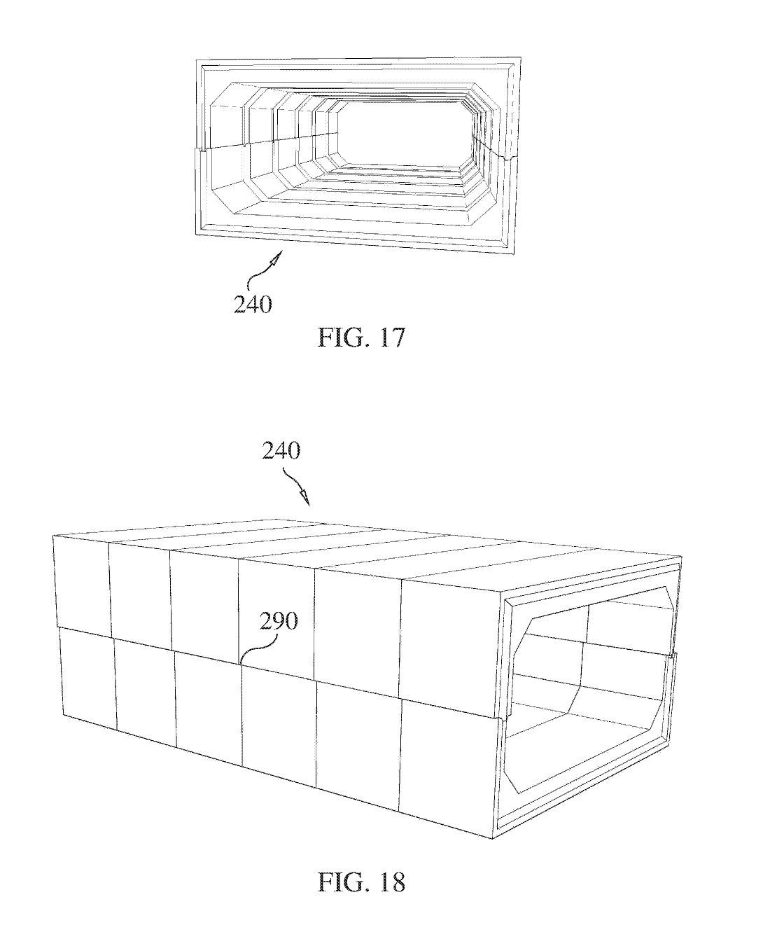

FIGS. 17 and 18 show a further embodiment wherein structure 240 is free of internal columns. Such a structure may be used for applications that require reduced load-bearing capacity and/or a smaller cross-sectional configuration.

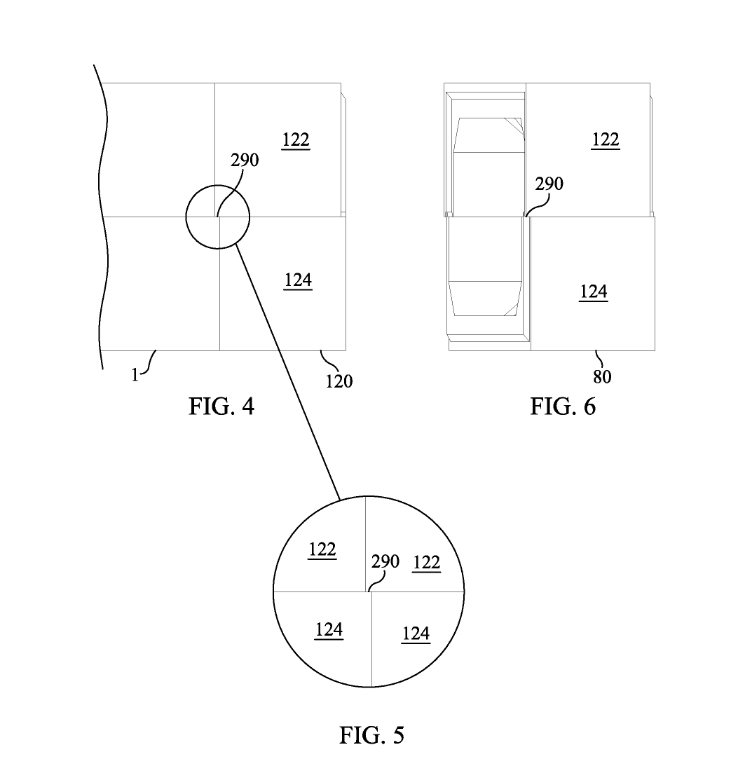

In one embodiment, shown in FIGS. 4-6 and 14-18, segments 122 and 124 may be assembled to be staggered in an axial direction wherein an upper segment overlaps bears on two lower segments. The vertical alignment of the respective sidewalls is maintained. According to this embodiment, an overlapping region 290 is generated. In order to generate the staggered effect, one of the segments has a reduced depth (e.g. axial length) and a second segment has an increased depth, by the same extent. The first and second segments are installed at respective ends of the assembled structured. When thus assembled, this permits the interior modules to have staggered walls, while the respective ends of the structure are fully aligned vertically.

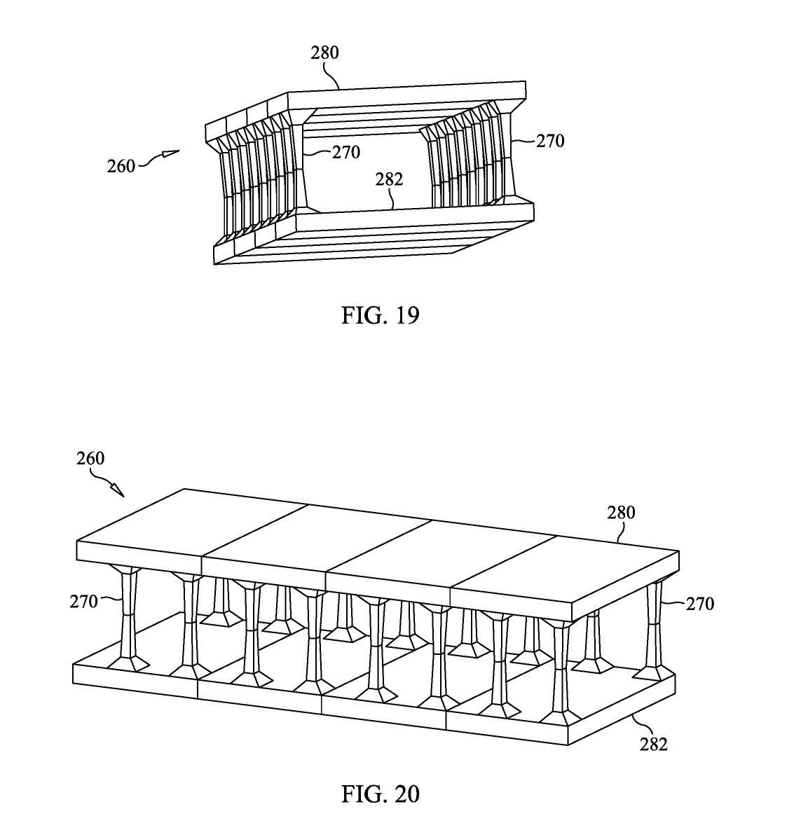

FIGS. 19 through 24 show further embodiments wherein structure 260 is free of both end and side walls. The embodiment shown in FIGS. 19 and 20 show a structure 260 is formed from upper and lower segments as described herein, which of which comprise paired two-part columns 270 as described herein. Columns 270 are located immediately adjacent to the side edges of upper and lower slabs 280 and 282, thereby providing similar structural support as continuous sidewalls. In other embodiments, columns 270 may be inboard of the sides of slabs 280 and 282, depending on structural requirements. The total number and configuration of columns will depend on structural requirements; by way of a non-limiting example, structure 260 (and the similar structures described herein) may comprise up to 5 pairs of columns for each module. The end surfaces of slabs 280 and 282 comprise the stepped, cantilever joint profiles described above. In this fashion, structure 260 may comprise a tiled arrangement of modules which are interlocked with cantilever joints in the axial dimensions.

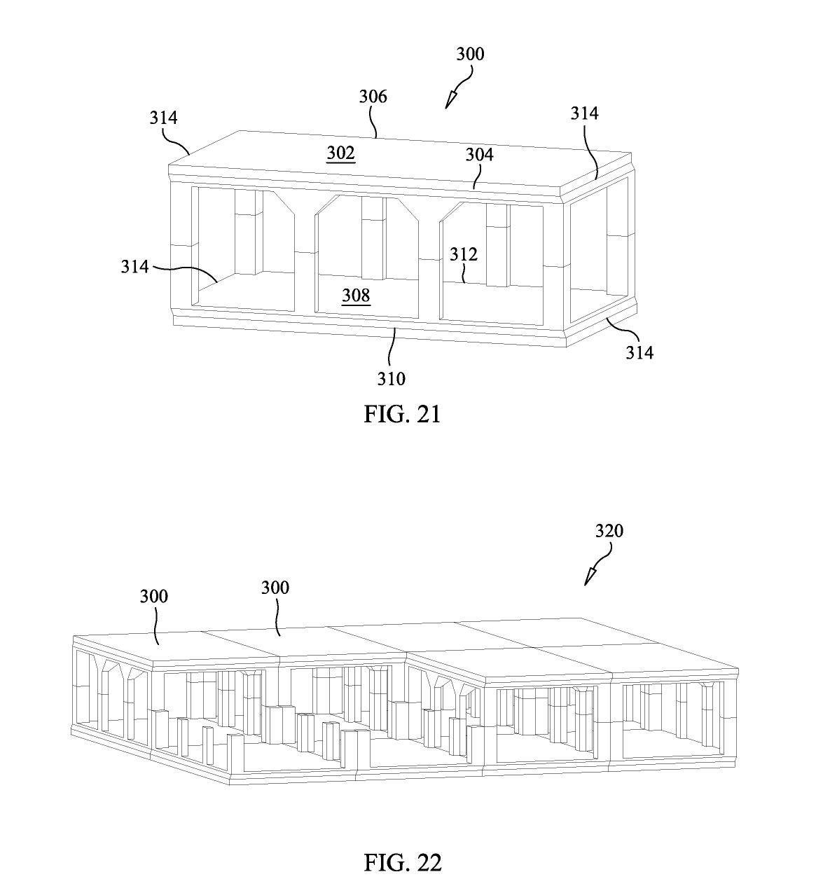

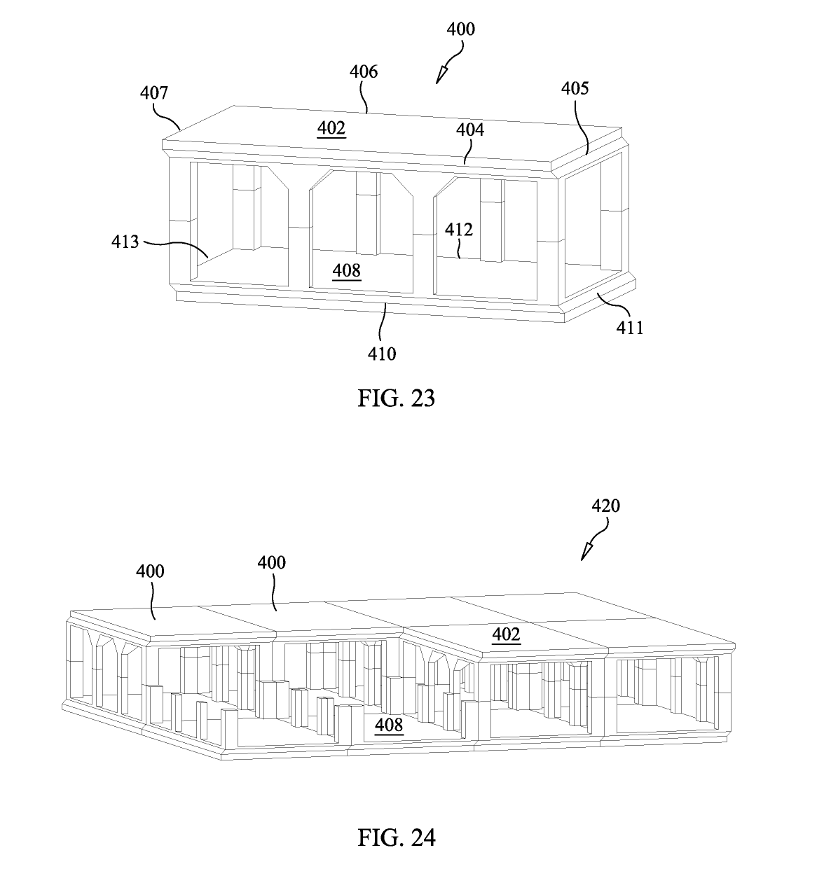

FIGS. 21 and 22 show a structure similar to FIGS. 19 and 20 but wherein cantilever joint profiles are provided on side surfaces of the upper and lower decks, rather than the end surfaces as shown in FIGS. 19 and 20. FIG. 21 shows a module 300 wherein the upper deck 302 comprises first and second opposing side (lateral) surfaces 304 and 306. Lower deck 308 likewise comprises first and second opposing side surfaces 310 and 312. Side surfaces 304 and 306 comprise cantilever joint profiles A and C. Side surfaces 310 and 312 comprise joint profiles B and D. The respective end surfaces 314 of the upper and lower decks are planar. In this fashion, a structure 320 may be assembled from these modules as shown in FIG. 22 wherein the cantilever joints interlock between adjacent modules 300 that are side by side laterally.

FIGS. 22 shows a structure 320 with two upper segments removed to show internal structure of the modules. It will be seen that modules 300 may be either aligned in both of these dimensions to form a checkerboard pattern as shown or staggered in one of these dimensions to form a tiled array (not shown).

FIGS. 23 and 24 show a further structure similar to FIGS. 19 and 20 but wherein cantilever joint profiles are provided on both of the end and side surfaces of the upper and lower decks. FIG. 23 shows a module 400 wherein the upper deck 402 comprises first and second opposing side (lateral) surfaces 404 and 406 and opposing end surfaces 405 and 407. Lower deck 408 likewise comprises first and second opposing side surfaces 410 and 412 and end surfaces 411 and 413. Side surfaces 404 and 406 comprise cantilever joint profiles A and C. Side surfaces 410 and 412 comprise joint profiles B and D. End surfaces 405, 407, 411 and 413 may likewise comprise joint profiles A through D. In this fashion, a structure 420 may be assembled from these modules as shown in FIG. 24 wherein the cantilever joints interlock between adjacent modules 300 in both of the axial and lateral (transverse) dimensions.

FIG. 24 shows an assembled structure 430 wherein the modules 432 comprise upper and lower decks 434 and 436 having cantilever joint profiles on the respective end and side surfaces thereof. In this fashion, interlocking cantilever joints are formed between axially and transversly aligned modules within structure 330. FIG. 24 shows structure 330 with two upper segments removed to show internal structure of the modules. It will be seen that modules 430 may be either aligned in both of these dimensions to form a checkerboard pattern as shown, or staggered in one of these dimensions to form a tiled array (not shown).

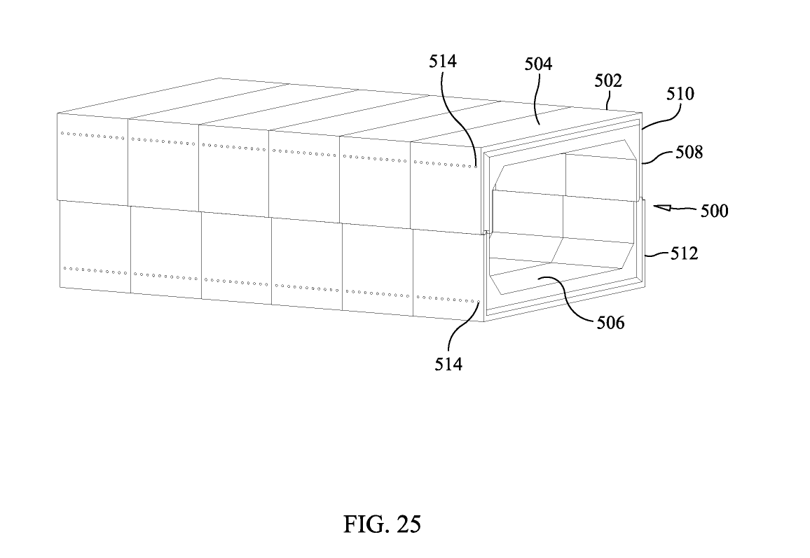

FIG. 25 provides a further embodiment, showing an assembled structure 400 formed from modules 402. Modules 402 are provided with upper and lower decks 404 and 406 respectively and sidewalls 408. Modules 400 are comprised of upper and lower segments 410 and 412 respectively are in inverted relationship to each other as described above. Segments 401 and 412 are free of internal columns whereby the assembled structure 400 has a fully open interior space. Segments 410 and 412 are fabricated from prestressed concrete to improve structural strength, which can be beneficial in certain applications such as relatively large unsupported spans. The pre-stressing may comprise either pre-tension and pos-tension. As is known in the art, pre-tension is applied before pouring of the concrete in the forming process and post-tension is applied after the pouring of the concrete. Tension is applied to reinforcing steel bars (not shown) that extend through openings 414 extending horizontally within the upper and lower decks 404 and 406 between the lateral edges of the structure. The tensioned bars apply an internal force that opposes external loads that the structure will bear in its lifetime to increase its strength. The tensioned bars are stressed to induce internal actions of a magnitude and distribution that the actions resulting from given external loading are counteracted to a desired degree.

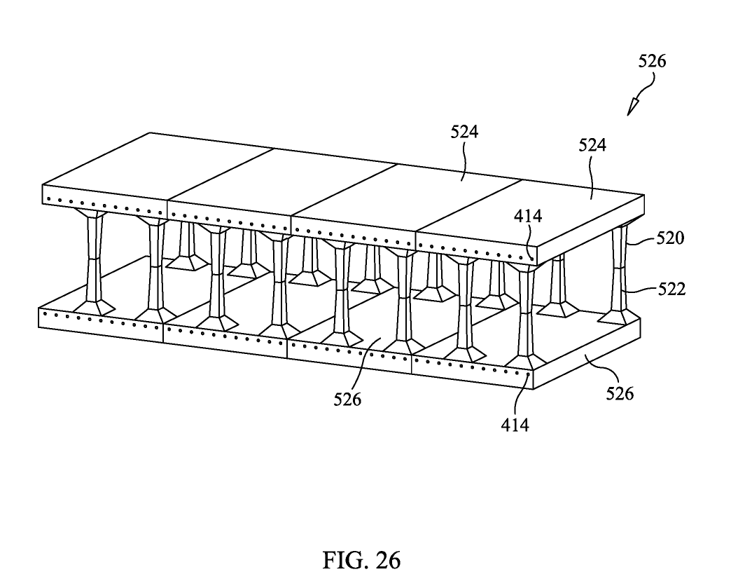

FIG. 26 provides a further embodiment similar to FIG. 25 but wherein the segments comprise upper and lower half-columns 420 and 422 respectively. This provides the assembled structure with columnar support between the upper and lower decks 404 and 406, in place of one or both of sidewalls 408.

It will be seen that one may provide a structure wherein the above embodiments of modules and segments are combined, such that certain of the modules include multiple columns, while others include different numbers of columns or are free of columns. For example, the end segments may require a reduced number of columns, due to the additional structural support provided by the end walls.

The segments according to the present invention may be fabricated by conventional concrete casting techniques, wherein concrete is poured into a mould and allowed to harden. As discussed above, the concrete may be reinforced and/or pre-stressed. The resulting segments may be transported to a remote location for assembly into finished structures.

Assembly of the segments into a finished structure may be performed by routine construction techniques. For example, a suitable trench or other excavation may be provided, which optionally is provided with footings or the like for additional support. The lower segments are then placed into position in axial (horizontal) alignment abutting each other whereby adjacent segments interlock, using a crane or other heavy lifting equipment to place the bottom segments. Following this step, the upper segments are then positioned on top of the lower segments whereby respective pairs of upper and lower segments are vertically aligned, thereby forming modules which are incrementally installed to form the finished assembly. Alternatively, each module may be assembled and installed individually, whereby installation occurs incrementally with each module being fully assembled before installation of a subsequent module. When assembled, the segments are all interlocked vertically and horizontally (axially), by the interlocking structures described herein including the tongue and groove features of the sidewalls, mortice and tenon features of the columns and cantilever joints of the decks. Furthermore, the cantilever joints serve to transmit loads between axially aligned segments, thereby minimizing the risk of the segments being urged out of alignment by vertical forces acting unequally on the segments.

The segments may be fabricated on the basis of a design that is based on specific requirements for a given installation. The design process may begins with identifying a set of potential constraints such as the size of the required structure, which may dictate the overall number of modules and segments. This can range from a small number of segments to the many hundreds. Soil bearing capacities of the sites in question are reviewed and segment sizes and weights may be adjusted accordingly. Trucking regulations govern the weight of each load, which in turn, may affect the configuration and size of the segments. Segment sizes and weights are designed to try and minimize trucking costs. Similarly, availability of heavy and expensive lifting equipment is taken into account in the design.

The scope of the invention should not be limited by the preferred embodiments set forth in the examples but should be given the broadest interpretation consistent with the description as a whole. The claims are not to be limited to the preferred or exemplified embodiments of the invention.

1. A modular system for assembling a hollow structure, comprising first and second segments each defined by opposing ends with an elongate axis between said ends and a deck having opposing sides and opposing ends, said deck comprising upper, lower, end and side surfaces, said first and second segments being configured for assembly in inverted, vertically aligned relation to each other to form a hollow module comprising opposed upper and lower ones of said decks, the first and second segments being configured to engage each other when assembled in vertically and/or axially aligned relationship with mutually engaging three dimensional structures configured to resist lateral and/or vertical slippage between the segments.

2. The assembly of claim 1 wherein said segments each comprise opposing sidewalls wherein the deck spans the sidewalls and respective sidewalls of said segments interlock with mutually engaging structures when assembled in vertically aligned relation to form structurally continuous outer walls of said module, wherein the mutually engaging structures are integral with said sidewalls.

3. The assembly of claim 1 wherein at least one of said decks comprises a first cantilever joint profile along at least one end or side edge surface thereof configured to interlock with a corresponding second cantilever joint profile in the deck of an adjoining horizontally-aligned segment, wherein the shelves of the respective first and second profiles are configured to rest one upon the other to transfer vertical forces between said modules.

4. The assembly of claim 3 wherein said at least one deck comprises opposing end or side surfaces wherein a first of said end or side surfaces comprises the first profile and the opposing end or side surface thereof comprises the second profile.

5. The assembly of claim 4 further comprising third and fourth cantilever joint profiles within upper and lower decks of a second one of said modules complementary to the profiles on the first of said modules.

6. The assembly of claim 4 wherein said deck comprises a third of said cantilever joint profiles different from the first and second profiles on a third side or end surface thereof, wherein said third profile is configured to interlock with said first or second profile in an abutting segment.

7. The assembly of claim 6 wherein said deck comprises a fourth of said cantilever joint profiles different from the first, second and third profiles on a fourth side or end surface thereof, wherein said fourth profile is configured to interlock with said first, second or third profile in an abutting segment.

8. The assembly of claim 3 wherein said module comprises first and second opposing end surfaces of the upper deck and third and fourth opposing end surfaces of the lower deck, wherein said first and second end surfaces comprise said first and second profiles and said third and fourth end surfaces comprise third and fourth profiles wherein said profiles interlock with axially modules comprising corresponding ones of said profiles in the upper and lower decks thereof.

9. The assembly of claim 2 wherein vertical end surfaces of said sidewalls comprise a joint structure continuous with the shelf structure of said deck.

10. The assembly of claim 1 wherein said segments are open at both ends thereof for assembly into an open-ended hollow four sided module.

11. The assembly of claim 1 wherein said segments comprise an end wall for assembly into a hollow five sided module having a closed end.

12. The assembly of claim 1 wherein said segments each further comprise at least one half-column protruding from a surface of said deck towards an opposing one of said segments whereby when said first and second segments are assembled in vertically aligned opposed relationship, said half columns abut each other at free ends thereof to form load-bearing continuous columns extending between opposing ones of said decks.

13. The assembly of claim 1 wherein said segments each further comprise at least one half-column protruding from a surface of said deck towards an opposing one of said segments whereby when said first and second segments are assembled in vertically aligned opposed relationship, said half columns abut each other to form weight-bearing continuous columns extending between opposing ones of said decks, and wherein said deck is supported solely by said columns.

14. The assembly of claim 12 wherein the free ends of said half-columns comprise interlocking projections and recesses.

15. The assembly of claim 12 wherein said half-columns taper inwardly away from said deck.

16. The assembly of claim 12 comprising a pair of said half columns aligned along an axis transverse to the elongate axis.

17. The assembly of claim 2 wherein the sidewalls of the first segments have lower edges comprising a tongue and groove structure configured to interlock with similar structures in the sidewalls of the second segments when assembled in vertical alignment.

18. The assembly of claim 2 wherein said vertical alignment comprises vertical alignment of said sidewalls and non-vertical alignment of the ends of said modules for assembly in a structure comprising an axially staggered array.

19. The assembly of claim 2 comprising openings in at least one of the side walls, end walls or decks.

20. The assembly of claim 5 comprising a first end module comprising two of said profiles on end surfaces of the upper and lower decks thereof, a second end module comprising two of said profiles complementary to the profiles of said first end module on upper and lower and decks thereof, and at least one middle module comprising all four of said profiles on opposing ends of said upper and lower decks.

21. The assembly of claim 1 wherein at least one of said segments comprises prestressed concrete.

22. A modular system for assembling a hollow structure, comprising first and second segments each defined by opposing ends with an elongate axis between said ends and a deck having opposing sides and opposing ends, said decks comprising upper, lower, end and side surfaces, said first and second segments being configured for assembly in inverted, vertically aligned relation to each other to form a hollow module comprising opposed upper and lower ones of said decks, wherein at least one of said decks comprises a first cantilever joint profile along at least one end or side edge surface thereof configured to interlock with a corresponding second cantilever joint profile in the deck of an adjoining horizontally-aligned segment, wherein the shelves of the respective first and second profiles are configured to rest one upon the other to transfer vertical forces between said modules.
